(19) United States
(12) Patent Application Publication
(10) Pub. No.: US 2012/0140782 A1
(43) Pub. Date: Jun. 7, 2012

(54) LOW TIMING JITTER, SINGLE FREQUENCY, POLARIZED LASER

(75) Inventors: Juan C. SOTELO, Hawthorne, CA (US); Robert D. STULTZ, Cypress, CA (US); David FILGAS, Newbury Park, CA (US)

(73) Assignee: RAYTHEON COMPANY, Waltham, MA (US)

(21) Appl. No.: 12/962,214

(22) Filed: Dec. 7, 2010

(51) Int. Cl. H01S 3/11; H01S 3/16; B23P 11/00; H01S 3/094

(52) U.S. Cl. 372/10; 372/75; 372/41; 29/428

(57) ABSTRACT

A laser system includes a first laser diode configured to generate first light in a first direction along an optical path; a laser resonator having a gain medium, anisotropic saturable absorber, and a wavelength selective outcoupler positioned in the optical path upon which the first light impinges a first side thereof so as to pump the gain medium (first light from the first laser diode is absorbed in the gain medium), a second laser diode configured to generate second light in a second direction along the optical path toward a second side of the resonator, passes through the wavelength selective outcoupler unimpeded and is absorbed by the saturable absorber element, wherein the second light has a polarization corresponding to the orientation of the saturable absorber; the wavelength selective outcoupler is configured to only allow third light of a predetermined wavelength to have feedback in the laser resonator, achieve gain in the resonator, and be emitted from the laser resonator. A method for forming a laser system is also described.

### BACKGROUND

This application generally relates to lasers, and in particular, to a low timing jitter, single frequency, polarized laser.

Conventional passively Q-switched lasers have been used without any attempt to reduce the timing jitter. For the systems that attempt to reduce the timing jitter they usually employ the following solutions: pulse pumping, pulse modulation, or usage of a separate modulated diode laser aimed and focused at the saturable absorber element.

In these lasers, the saturable absorber is typically bonded onto the gain medium and mirrors are coated onto each facet of the microchip making a laser resonator. For instance, anisotropic saturable absorbers exist for wavelengths near 1 micron, which can be bonded with the gain medium. Chromium yttrium aluminum garnet (Cr:YAG) is one such example of an anisotropic saturable absorber.

This monolithic design is used on a variety of applications, and is capable of producing average powers of up to a few Watts. These lasers are typically end pumped with laser diodes or fiber coupled laser diodes. The output of a high power fiber coupled laser diode may be uniform, but has random polarization because the fiber core is usually large (e.g., greater than 100 microns). The uniform output provides a convenient way to relay the pump light into the microchip and obtain different spot sizes.

However, to maintain single transverse mode operation, the spot size usually varies between several tens of microns to hundreds of microns. The laser pulse energy increases as the spot size increases, however, not linearly. The resulting output pulse may be single mode spatially, but the laser does not enable single frequency operation, polarized output, or minimize timing jitter. In addition, other lasers have used a single longitudinal mode control mechanism, but without timing jitter control or polarization control.

In light of these drawbacks, an improved passively Q-switched laser is desired.

### SUMMARY

In an embodiment, a laser system comprises: a first laser diode configured to generate first light in a first direction along an optical path, the laser resonator is comprised of a gain medium, an anisotropic saturable absorber, and a wavelength selective outcoupler, positioned in the optical path upon which first light impinges a first side thereof so as to pump the gain medium. First light from the first laser diode is absorbed in the gain medium. A second laser diode configured to generate second light in a second direction along the optical path toward a second side of the laser resonator, passes through the wavelength selective outcoupler unimpeded and is absorbed by the saturable absorber, causing it to bleach, wherein the second light has a polarization corresponding to the orientation of the saturable absorber. A wavelength selective outcoupler is configured to only allow third light of a predetermined wavelength to have feedback, achieve gain in the resonator, and be emitted by the laser resonator.

These and other aspects of this disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not a limitation of the invention. In addition, it should be appreciated that structural features shown or described in any one embodiment herein can be used in other embodiments as well.

### BRIEF DESCRIPTION OF THE DRAWINGS

FIG. 1 illustrates a schematic of an exemplary laser, in accordance with an embodiment.

FIG. 2 is a plot of transmission characteristics for one known Cr:YAG saturable absorber which may be used in a laser resonator, in accordance with an embodiment.

FIGS. 3A and 3B are plots showing wavelength control of laser resonator using wavelength selective outcoupler in accordance with an embodiment. FIG. 3A shows the normalized intensity of light transmitted through the laser resonator without using the wavelength selective outcoupler. FIG. 3B shows the normalized intensity of light transmitted through the laser resonator using the wavelength selective outcoupler.

FIG. 4 depicts synchronizing the pulse of the laser resonator by the second laser diode, in accordance with an embodiment.

FIG. 5 is a plot of pump power and pulse repetition frequency for a laser system, in accordance with an embodiment.

FIG. 6 is a plot of energy and pulsewidth for the laser system, in accordance with an embodiment.

### DETAILED DESCRIPTION

In light of the aforementioned drawbacks, the inventors considered various factors that they believed contribute to lowering the timing jitter in lasers. These included, among other things, pulse pumping, pump modulation, and bleaching of the saturable absorber with an additional light source.

Pulse pumping is a technique in which the pump source is turned ON and OFF in synchronization with the laser output pulse. This is an effective way to control the timing jitter, but has not been found to be highly effective and typically limits the pulse repetition frequency (PRF), for instance, to several kHz.

Pump modulation is a technique in which the pump always remains ON, but in which pumping is increased significantly when the laser pulse is desired. This technique is similar to pulse pumping, but adds a direct current (DC) bias to the pump source. By using pump modulation, a PRF greater than tens of kHz may be obtained, but the reduction in timing jitter is generally mild (i.e., about 2% of the PRF).

Bleaching is a technique in which an additional laser source, such a laser diode, is aimed and focused on the saturable absorber of the laser resonator in the region where the primary laser pulse is emitted. The additional laser diode can be coupled to the saturable absorber, for example, by: a dichroic coating, off-axis geometric coupling, co-axial geometric overlap, or the use of a volume Bragg grating. In operation, the primary laser diode pumps the gain medium and provides gain while the second laser diode bleaches the saturable absorber. This technique offers the possibility of high PRF's (e.g. up to hundreds of kHz) and significantly reduced timing jitter (e.g. about 1% of the PRF).

Timing jitter may be further reduced by increasing the power from the additional bleaching laser diode. However, for a conventional high power fiber coupled single strip laser diode with a 100 μm core and 0.15 NA, the average power for the bleaching laser diode is only about 10 W. In addition, timing jitter may also be improved by decreasing the number of longitudinal modes propagating. To promote single longitudinal mode operation, the laser cavity length may be reduced such that the mode spacing is equal to or larger than the gain medium bandwidth. Accomplishing this, however, places limitations on pulse energy and pulsewidth of the microchip resonator.

Single longitudinal mode operation has been obtained in microchips using a Volume Bragg Grating (VBG) which only provides feedback for one mode. The utilization of a VBG enables different laser configurations with increased cavity lengths, thus enabling significantly higher average power and average pulse energy while maintaining single frequency operation. The utilization of a VBG to force the laser into single frequency operation in conjunction with the second bleaching laser diode results in a significant reduction in timing jitter.

To further lower the timing jitter, the output polarization of the laser may be limited to one polarization state using: stress-induced birefringence in the gain medium or saturable absorber, anisotropic coatings, an anisotropic gain medium, and/or an anisotropic saturable absorber. Stress-induced birefringence is when the gain medium or saturable absorber is intentionally over-constrained in the mounting or cooling apparatus. The induced birefringence is such that a single polarization is preferred causing the laser output to be polarized. This approach can produce stable results under certain environments, but typically the polarization extinction ratio is low and repeatability may be an issue. Anisotropic coating may be used, however, these can be damaged easily in operation. Gain mediums with anisotropy may also have sufficient performance, but they require the pump to be polarized and may not be suitable for all wavelengths.

Having evaluated these various techniques and technologies, the inventors developed a low timing jitter, single frequency, polarized laser. According to one or more embodiments, a laser system comprises: a first laser diode configured to generate first light in a first direction along an optical path; a laser resonator that is composed of a gain medium, an anisotropic saturable absorber, and a wavelength selective outcoupler, positioned in the optical path upon which first light impinges a first side thereof so as to pump the gain medium, light from the first laser diode is absorbed in the gain medium, a second laser diode configured to generate second light in a second direction along the optical path toward a second side of the laser resonator, will pass through the outcoupler and will be absorbed by the saturable absorber, forcing it to bleach, wherein the second light has a polarization corresponding to the orientation of the saturable absorber, a wavelength selective outcoupler that is part of the laser resonator, is configured to only allow a third light of a predetermined wavelength to have feedback, acquire gain, and to be emitted from the laser resonator.

This laser has been found to provide very low timing jitter (e.g., about 0.1% of the PRF period), single frequency operation, controlled output polarization, and low pulse-to-pulse energy variation (e.g., about 1%). More particularly, the combination of the anisotropic saturable absorber to promote a polarized output, the wavelength selective outcoupler to provide single frequency operation, and the (bleaching) second laser diode to reduce the timing jitter, provide a significant reduction in timing jitter that was not realized with conventional lasers having a bleaching second laser diode.

Although the birefringence in laser resonators is generally mild, polarization extinction can be increased by using a slightly polarized pump source from the second laser diode. Moreover, if the residual pump light that reaches the saturable absorber is parallel with the orientation of the pumping light polarization, then the resulting polarization extinction ratio can exceed, for instance, 20 dB. The high polarization extinction ratio improves timing jitter by forcing the laser to emit light along only one axis.

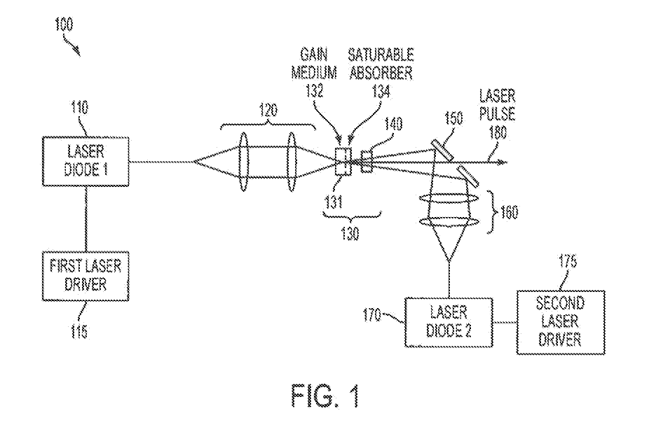

FIG. 1 illustrates a schematic of exemplary laser 100 in accordance with an embodiment. Laser 100 is configured as a passively Q-switched laser.

Laser 100 generally includes first laser diode 110, first current driver 115, first relay optics 120, laser resonator 130 (comprised of composite lasing medium 131—that is formed of gain medium 132 and saturable absorber 134—and wavelength selective outcoupler 140), mirror 150, second relay optics 160, second laser diode 170, and current driver 175.

First laser diode 110 is configured to pump the composite lasing medium 131 formed of gain medium 132 and saturable absorber 134 and wavelength selective outcoupler 140. First laser diode 110 may be, for example, a laser diode manufactured by LIMO Lissotschenko Mikrooptik GmbH. For instance, first laser diode 110 may be a 940 nm fiber coupled laser diode having 100 μm/125 μm core/clad (NA=0.22) and operated at about 5 W. First laser diode 110 may be controlled by first current driver 115, which may be configured to operate first laser diode 110 either in a continuously or pulsed mode.

First relay optics 120 may include one or more (two shown) lens elements configured to transmit light from first diode to gain medium 132 and saturable absorber 134. In one implementation, two lens elements may be provided having focal lengths of 100 mm and 80 mm, respectively (left-to-right in figure) to relay and focus light from first last diode 110.

Saturable absorber 134 may be composed of a saturable absorber material having a predetermined orientation. Saturable absorber 134 may be anisotropic that promotes polarized laser pulses, and results in very low timing jitter values. In one embodiment, gain medium 132 and saturable absorber 134 may be formed together as composite lasing medium 131 that is constructed by diffusion or adhesive-free bonding the gain medium with the saturable absorber (e.g., at an elevated temperature below the melting point thereof), such as, for example, disclosed in U.S. Pat. No. 5,394,413, herein incorporated by reference, in its entirety. The facets of the composited lasing medium 131 may be mirrored.

In some instances, gain medium 132 may be ytterbium yttrium aluminum garnet (Yb:YAG) and the saturable absorber may be chromium yttrium aluminum garnet (Cr:YAG). For instance, in one embodiment, the Cr:YAG saturable absorber 134 may be cut and polished so as to be oriented in the <110> orientation. In this orientation, the material properties of the crystal will be in birefringement, thus allowing laser 100 to favor a single polarization state. For highest transmission, the polarization of light from second laser diode 170 will be parallel to the orientation of the saturable absorber.

Of course, it will be appreciated that other gain mediums 132 and/or saturable absorber 134 materials might also be used. For example, some other gains mediums may include: neodymium yttrium aluminum garnet (Nd:YAG), holium yttrium aluminum garnet (Ho:YAG), and erbium yttrium aluminum garnet (Er:YAG). And, some other saturable absorbers may include: vanadium yttrium aluminum garnet (V³⁺:YAG), cobalt spinel (Co²⁺:MgAl2O4), and bis 4-dimethyl-aminodithiobenzil-nickel (BDN). Some of these may be dissolved, for example, in 1,2-dichloroethane (BDN in a cellulose acetate).

Composite lasing medium 131 including gain medium 132 and saturable absorber 134 are end pumped using light from first laser diode 110. Spot sizes on gain medium 132 and saturable absorber 134 can be varied to change the pulse energy, for instance, on the order of about 10 to 100 microns for single spatial mode operation. The pulsewidth can be varied, for instance, on the order of about a few nanoseconds. It will be appreciated that laser resonator 130 may require some time to thermally stabilize. The center wavelength tends to increase slightly as laser resonator 130 heats up. Laser resonator 130 may inherently exhibit multiple modes if care in temperature or design is not exercised. If so, the timing jitter will not be optimal (i.e., minimized) and fluctuate.

Thus, wavelength selective outcoupler 140 of laser resonator 130 may be configured to enable the laser 100 to operate in a single longitudinal mode, thus providing low energy variation. More particularly, wavelength selective outcoupler 140 is a passive device.

The beam formed from laser resonator 130, may have only have one longitudinal mode. In some instances, wavelength selective outcoupler 140 may be a Volume Bragg Grating (VBG), an etalon, or the cavity length of the gain medium and saturable absorber can be made sufficiently small to only allow one mode of operation.

A VBG may be formed of a bulk piece of glass or polymer and having a spatially modulated interference optical grating pattern. VBGs may be configured for use as wavelength selective outcoupler 140, based on, among other things, wavelength, reflectivity, (light) acceptance angle and physical size. One benefit of using VGBs is that they generally have a low sensitivity to temperature.

According to one implementation, wavelength selective outcoupler 140 may be configured to have a center reflectivity and bandwidth at approximately 1030.45 nm. This particular wavelength is selected to co-align with the peak gain cross section of our gain medium. Other wavelength selective outcouplers may also be used having different wavelength transmission characteristics. For example, an etalon is an optical interferometer is which can function as a very precise narrowband wavelength filter.

Mirror 150 may include any mirror element having a hole or other aperture adapted to allow a primary pulse from the laser resonator 130 to pass through while reflecting light from the second laser diode 170. For instance, mirror 150 may be a conventional silvered mirror including an aperture. And, in one embodiment, the aperture may be about 0.1 in diameter.

Second relay optics 160 may include one or more (two shown) lens elements configured to transmit light from second laser diode 170 to saturable absorber 134 and gain medium 132 via mirror 150 and through wavelength selective outcoupler 140. In one implementation, two lens elements may be provided having focal lengths of 100 mm and 80 mm, respectively (bottom-to-top in figure), to relay and focus light from second last diode 170.

Second laser diode 170 is configured to provide a polarized beam controlled by second current driver 175. Second laser diode 170 may also be referred to as a “bleaching” laser diode, which acts as a switch to help force laser resonator 130 to pulse. Second laser diode 170 may be configured to be turned ON when a pulse from laser resonator 130 is desired. It may be configured to turn OFF (i) after such a pulse emission or (ii) set to a fixed pulse length. In some instances, second laser diode 170 may be a fiber coupled laser diode with a shortened multimode fiber to help maintain linear polarization of the pulse beam. For example, in one implementation, second laser diode 170 may be a 940 nm fiber coupled laser diode having 100 μm/125 μm core/clad (NA=0.15) and operated at about 25 W. Laser diodes of this configuration are commercially available, for example, from Bookham, Inc. Second current driver 175 may be a pulsed current driver and may be configured to generate 0.5-1.0 μs pulsewidth operating at 8 Amps and having a frequency of 20 kHz. The polarization of the second laser diode 170 is configured to be substantially parallel with the orientation of laser resonator 130.

Laser 100 provides pulsed operation, single mode operation (e.g., TEM₀₀), low pulse energy variation, single frequency (single longitudinal mode), and is linearly polarized.

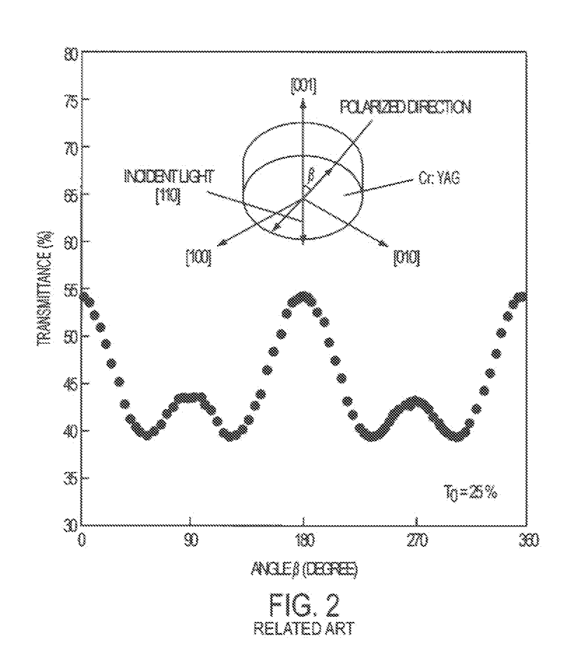

FIG. 2 is a plot of transmission characteristics for one known Cr:YAG saturable absorber 134 which may be used in a laser resonator 130 in an embodiment. Aspects of this Cr:YAG saturable absorber are described in H. Sakai et al. “Polarization stabilizing for diode-pumped passively Q-switched Nd:YAG microchip lasers” Optical Society of America, 2005, herein incorporated by reference in its entirety. This particular saturable absorber, with <110> crystal orientation, is bonded with the gain medium to form composite lasing medium 131. In some instances, composite lasing medium 131 may be fabricated as a microchip laser as discussed, for example, in the aforementioned article. The manufacturer of this saturable absorber could be Scientific Materials or VLOC or other crystal manufacturers.

The plot in FIG. 2 shows that transmission of incident light through the saturable absorber as a function of the polarization angle β (i.e., corresponding to the polarization direction of the incident light normal to the surface of the saturable absorber). As will be appreciated, at an angle β of about 0 or 180 degrees, the transmission of the saturable absorber is at a maximum. This corresponds to light impinging the saturable absorber having a polarization state substantially parallel to the <001> crystal orientation of the saturable absorber. Other polarization states of the incident light are significantly lower.

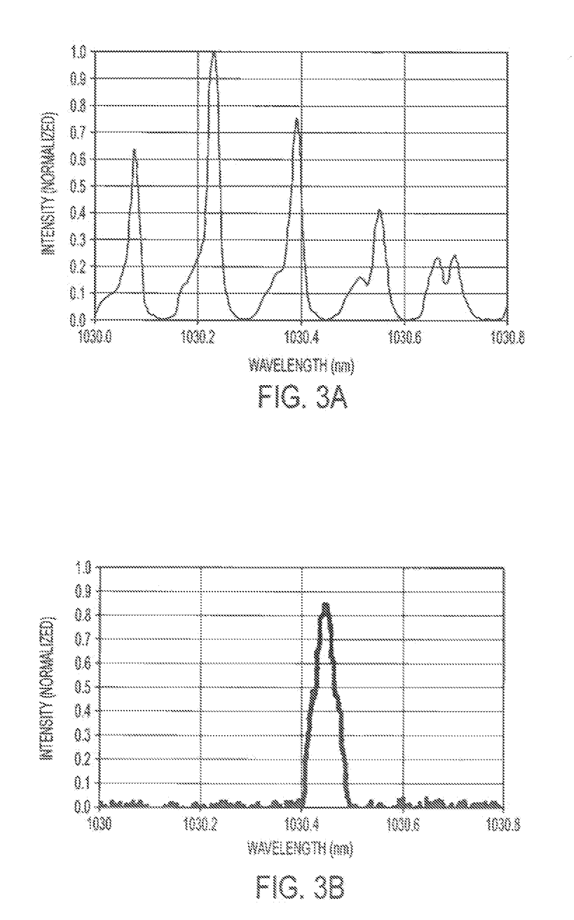

FIGS. 3A and 3B are plots showing timing jitter control of laser 100 using wavelength selective outcoupler 140 in accordance with an embodiment. The results shown in these plots were measured using a 10 pm resolution optical spectrum analyzer (OSA).

FIG. 3A shows the normalized intensity of light of a laser resonator without using wavelength selective outcoupler 140. The wavelength of operation for this implementation of laser 100 is intended to be about 1030.4 nm. However, various peaks occur having a spectral width of about 0.2 nm (20 pm). Each peak corresponds to a longitudinal mode of the laser resonator.

FIG. 3B shows the normalized intensity of light from the laser resonator 130. As will be appreciated, only one peak in the wavelength is seen, with all other peaks have been eliminated. The light transmitted corresponds to the operative wavelength of the wavelength selective outcoupler, around 1030.4 nm, having a spectral width around about 40-60 pm.

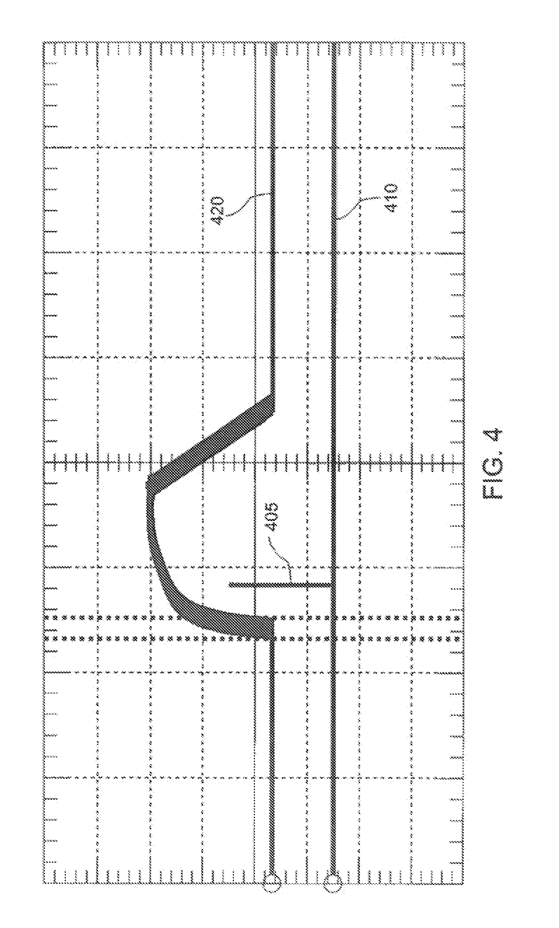

FIGS. 4 to 6 show plots of various operating parameters of the laser 100 in accordance with embodiments.

FIG. 4 depicts synchronizing the pulse of laser resonator 130 by second laser diode 170, in accordance with an embodiment.

Line 410 shows multiple laser pulses from laser resonator 130, overlapped on top of each other. Line 420 shows multiple optical pulses from second laser diode 170. The width of line 420 illustrates the timing jitter experienced by the laser resonator. The plots show tens of thousands, if not more, pulses overlaid. In one example, 92,000 pulses were monitored.

Laser resonator 130 generates pulses, depicted as pulse 405, in response to a pulse from second laser diode 170. In this example, the output of the second laser diode 170 was 18 W peak power, achieved by pulsing with 8.4 Amps at a 0.5 μs pulsewidth. The output power of laser 100 was 1.08 W, having a pulsewidth of 820 ps. The timing jitter is depicted as the thickness of line 420. In this case, the timing jitter was measured to be about 40 ns. The current pulse line 420 of second laser diode 170 shifts with respect to the laser pulse 405.

Results show that by using laser 100, the timing jitter has been lowered by approximately 2 orders of magnitude (e.g., 20 dB). Moreover, it has been found that for pump power of first laser diode 110 to be between about 4.6-5.2 W, optimal performance is obtained.

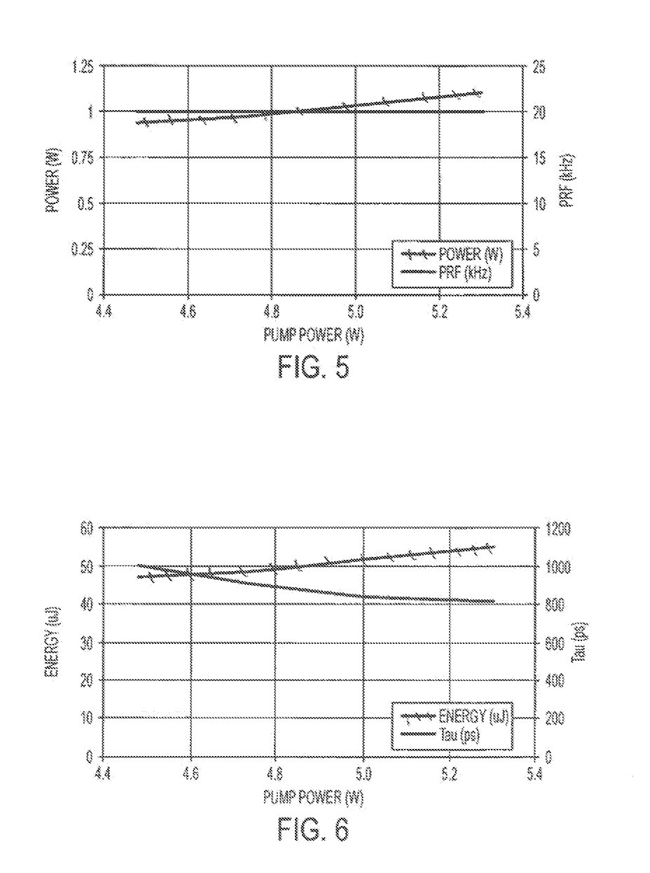

FIG. 5 is a plot of pump power and PRF for laser 100 in accordance with an embodiment. The pulse energy only slightly increases as the pump power from first laser diode 110 varies. Moreover, second diode 170 keeps the PRF maintained constant at about 20 kHz for a wide range of pump powers.

FIG. 6 is a plot of energy and pulsewidth (i) for laser 100, in accordance with an embodiment. As the pump power of first laser diode 110 increases, the energy per pulse increases slightly and pulsewidth decreases over that range ultimately approaching the pulsewidth that would have been seen if the second laser diode were off.

Laser 100 enables passively Q-switched lasers to reach timing jitter performance levels that were only previously observed in actively Q-switched lasers. As discussed above, laser 100 combines a gain medium 132 and saturable absorber 134 having an anisotropic saturable absorber with a predetermined orientation, second laser diode 170 to generate second light having a polarization corresponding to the orientation of the saturable absorber 134; and wavelength selective outcoupler 140 to only allow operating light of a predetermined wavelength to obtain feedback and achieve gain, into a single system.

Second laser diode 170 is aimed and focused on saturable absorber 134 of laser resonator 130 in region where laser output is emitted, enabling timing jitter control. Wavelength selective outcoupler 140 enables the laser to operate in a single frequency, thus providing low energy variation. Saturable absorber 134 and polarized output of second laser diode 170, provides laser polarization control.

The various embodiments described herein provide low timing jitter, single longitudinal mode, output polarization control in a robust, and a passive microchip laser design. Many laser and/or laser radar (LADAR) systems may benefit from this enhanced performance.

Other embodiments, uses and advantages of the inventive concept will be apparent to those skilled in the art from consideration of the above disclosure and the following claims. The specification should be considered non-limiting and exemplary only, and the scope of the inventive concept is accordingly intended to be limited only by the scope of the following claims.

What is claimed is:

1. A laser system comprising:
a first laser diode configured to generate first light in a first direction along an optical path;
a laser resonator having a gain medium, an anisotropic saturable absorber, and a wavelength selective outcoupler, positioned in the optical path upon which the first light impinges a first side thereof so as to pump the gain medium,
a second laser configured to generate second light in a second direction along the optical path toward a second side of the laser resonator, the second light passes through the outcoupler and impinges on the saturable absorber element to cause the saturable absorber to bleach, wherein the second light has a polarization corresponding to the orientation of the saturable absorber; and
wherein the wavelength selective outcoupler that is part of the laser resonator is configured to only allow third light of a predetermined wavelength to have feedback, achieve gain, and be emitted by the laser resonator.

2. The laser system according to claim 1, wherein the polarization of the second light is parallel with the orientation of the saturable absorber.

3. The laser system according to claim 1, wherein the pump power of first laser diode is between about 4.6-5.2 W.

4. The laser system according to claim 1, wherein, in operation of the laser system, the laser resonator is synchronized with the second laser diode.

5. The laser system according to claim 1, wherein, in operation of the laser system, the first laser diode is operated continuously or pulsed.

6. The laser system according to claim 1, wherein, in operation of the laser system, the second laser diode is pulsed.

7. The laser system according to claim 1, wherein the gain medium and the saturable absorber comprise a composited lasing medium.

8. The laser system according to claim 7, wherein the composite lasing medium is a microchip.

9. The laser system according to claim 7, wherein facets of the composite lasing medium are mirrored.

10. The laser system according to claim 1, wherein the gain medium and the saturable absorber are diffusion or adhesive-free bonded together.

11. The laser system according to claim 1, wherein the gain medium is selected from the group consisting of: ytterbium yttrium aluminum garnet (Yb:YAG), neodymium yttrium aluminum garnet (Nd:YAG), holium yttrium aluminum garnet (Ho:YAG), and erbium yttrium aluminum garnet (Er:YAG).

12. The laser system according to claim 1, wherein the saturable absorber is selected from the group consisting of: chromium yttrium aluminum garnet (Cr:YAG), vanadium yttrium aluminum garnet (V³⁺:YAG), cobalt spinel (Co²⁺:MgAl2O4), and bis 4-dimethyl-aminodithiobenzil-nickel,

13. The laser system according to claim 12, wherein the saturable absorber is dissolved in 1,2-dichloroethane (BDN in a cellulose acetate).

14. The laser system according to claim 1, wherein the saturable absorber is cut and/or polished to have the predetermined orientation.

15. The laser system according to claim 14, wherein the predetermined orientation of the saturable absorber is the <110> crystal orientation.

16. The laser system according to claim 14, wherein the material properties of the saturable absorber are in birefringement,

17. The laser system according to claim 1, wherein wavelength selective outcoupler is selected from the group consisting of: (i) a Volume Bragg Grating (VBG), (ii) an etalon and (iii) the cavity length of the gain medium and saturable absorber is selected so as to only allow 1 mode of operation.

18. The laser system according to claim 1, wherein the laser system is a passively Q-switched laser.

19. The laser system according to claim 1, further comprising a mirror having an aperture, the mirror reflecting second light from the second laser to the laser resonator and the aperture allowing the third light to pass through the mirror.

20. A method for forming a laser system comprising:
positioning a first laser diode that is configured to generate light in a first direction along the optical path to pump a laser resonator;
selecting an anisotropic saturable absorber having a predetermined orientation for use in the laser resonator;
positioning a second laser diode that is configured to generate second light having a polarization corresponding to the orientation of the saturable absorber, in a second direction along the optical path, toward the side of the saturable absorber element to cause the saturable absorber to bleach; and
positioning a wavelength selective outcoupler in the optical path to form a laser resonator and to allow light of a predetermined wavelength to have feedback, achieve, gain, and be emitted by the laser resonator.
